(19) United States
(12) Patent Application Publication
(10) Pub. No.: US 2009/0064867 A1
(43) Pub. Date: Mar. 12, 2009

(54) STIR COOKER

(76) Inventor: Zheng Peng, Ypsilanti, MI (US)

Correspondence Address: ZHAOXIA XU, 4694 SYCAMORE DR., YPSILANTI, MI, 48197, US

(21) Appl. No.: 11/851,002

(22) Filed: Sep. 6, 2007

(51) Int. Cl. A47J 36/00

(52) U.S. Cl. 99/331; 99/337; 99/341; 99/348

(57) ABSTRACT

A stir cooker (100). Stir cooker (100) comprises a container (102) having an open top and an open bottom for holding food, a lid (104) for closing the open top of container (102), a heated bottom (106) sealingly engaged with the lower end of container (102) for forming a cooking chamber (103), stir means (114) installed inside cooking chamber (103) for stirring food, a heating tube (116) fixedly installed on the bottom of heated bottom (106) for heating food, a stir base (112) disposed underneath cooking chamber (103) for supporting cooking chamber (103), a motor (124) installed inside stir base (112) and removably coupled with stir means (114) for driving stir means (114) to stir food, and an adapting member (110) engaged with the lower portion of container (102) by means of threading for adapting cooking chamber (103) to stand on stir base (112).

### TECHNICAL FIELD AND INDUSTRIAL APPLICABILITY OF THE INVENTION

This invention generally relates to cooking appliances. More specifically, this invention relates to a stir cooker that combines heating and stirring for cooking food and that is especially suited for cooking a smaller portion of food, such as sauces, dips, chocolate, cheese, etc.

### BACKGROUND OF THE INVENTION

Traditional cookers have a container sitting on a heater that has a thermal diffusion plate and a heating tube installed on the bottom of the diffusion plate and a handle for use of handling the container. When cooking, people have to stir food to facilitate heat transfer and uniform heating of food. Such cooking techniques include stir-frying, sautéing, braising, simmering, etc.; which require skills and labor.

In order to automate cooking processes, a stirring mechanism, which is installed inside the container for stirring food, has been proposed to facilitate heat transfer and uniform heating. The stirring mechanism is the key for cooking automation for fast and quality cooking of food and a “technological breakthrough” over traditional ways of cooking. Immediate advantages include: facilitated heat transfer and more uniform heating to save time and energy; reduced labor and skill requirements to consumers; closed lid on pan/pot to avoid cooking fumes and food splashing for home environment protection, at the same time, to save energy.

U.S. Pat. No. 6,845,707, issued to Xu, et al., on Jan. 25, 2005, teaches regarding an automatic cooking apparatus having a stirrer installed inside an inner pan for automated stirring and cooking.

U.S. Pat. No. 4,649,810, issued to Wong, on Mar. 17, 1987, illustrates an automatic cooking apparatus having a compartmentalized carousel for various ingredients of a particular dish to be loaded and a stirring blade generally conforming to the shape of the bottom of a cooking vessel. As the blade revolves around a vertical axis, it causes the foods to spread and to roll over the top of the blade.

However, the aforementioned products are suited for cooking a larger portion of food, from a structural design point of view, for examples, for cooking regular meals serving a family. When used for cooking a smaller portion of food, which is quite common when cooking such food as dips, sauces, chocolate, cheese, etc., these products are awkward to use due to their larger sizes.

The very unique aspect of cooking small quantity of food is that the cooker should be smaller than regular cookers. Stir cookers previously developed on the market are too large and they are highly inconvenient for handling and more difficult for cleaning after use due to their large sizes. The cleaning after use of a smaller cooker is going to be the key issue to deal with. On the other hand, how to incorporate heating and stirring for a small appliance remains a technological challenge, from a structural design point of view. Safety for use is a further more important aspect to take care of.

Therefore, it remains desirable to provide a stir cooker that combines heating and stirring for cooking food, that is suited for cooking a smaller portion of food more conveniently and more easily, that saves time and efforts, that is safe to use, that is convenient for cleaning after use, and that saves energy and cost for general public.

### BRIEF SUMMARY OF THE INVENTION

Accordingly, the present invention is a stir cooker. This stir cooker comprises a container having an open top and an open bottom for holding food, a lid for closing the open top of the container, a heated bottom sealingly engaged with the lower end of the container for forming a cooking chamber, stir means installed inside the cooking chamber for stirring food, an electrical heating tube fixedly installed on the bottom of the heated bottom for heating food, a stir base disposed underneath the cooking chamber for supporting the cooking chamber, a motor installed inside the stir base and removably coupled with the stir means for driving the stir means, and an adapting member engaged with the lower portion of the container by means of threading for adapting the cooking chamber to removably stand on the stir base.

Accordingly, the followings are some of the objects, features, and advantages of the present invention.

It is an object of the present invention to provide a stir cooker that is especially suited for cooking a smaller portion of food.

It is a feature of the present invention that this stir cooker includes a container having a tubular configuration, which is highly convenient for cleaning after use and dishwasher safe.

It is another feature of the present invention that the container has a tubular configuration with an open bottom and that, as the container is tightened onto an adapting member by means of threading, a seal is generated between the lower end of the container and the open top of a heated bottom to form a cooking chamber. The container is, therefore, removable from the heated bottom, such that both the container and the heated bottom are convenient for cleaning after use.

It is a further more feature of the present invention that an electrical heating tube is fixedly installed on the bottom of the heated bottom, such that the efficiency of heat transfer is high to save time and energy for cooking food.

It is an advantage of the present invention that this stir cooker is highly convenient to use for cooking a smaller portion of food.

It is another advantage of the present invention that this stir cooker is highly convenient for cleaning after use.

Further more features and advantages of the present invention will be readily appreciated, as the same becomes better understood after reading the subsequent description when considered in connection with the non-limiting accompanying drawings.

### BRIEF DESCRIPTION OF THE DRAWINGS

FIG. 1 illustrates a cross-sectional view of an embodiment of the present invention, a stir cooker 100.

FIG. 2 illustrates an exploded cross-sectional view of seal device 130 and coupling device 132.

FIG. 3 illustrates a bottom view of heated bottom 106.

FIG. 4 illustrates a bottom view of adapting member 110.

FIG. 5 illustrates a top view of stir base 112.

FIG. 6 illustrates another cross-sectional view of stir cooker 100.

### DETAILED DESCRIPTION OF THE INVENTION

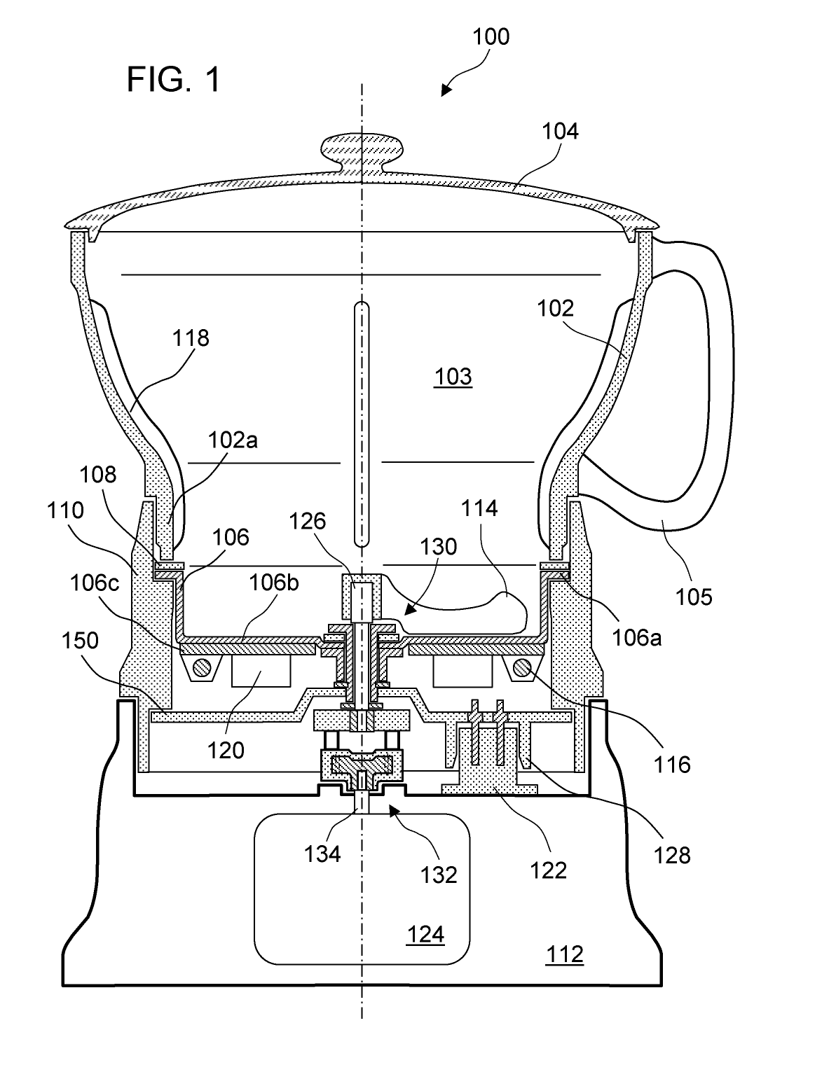

Reference is made to FIG. 1, which illustrates a cross-sectional view of an embodiment of the present invention, a stir cooker 100.

A container 102, having an open top and an open bottom, is provided for holding food. Container 102 has a generally tubular configuration with a slightly larger top and is preferably made from a transparent material. Threading 102a, integrally formed at the lower end of container 102, is provided for engaging with other components. A handle 105 is fixedly installed on the sidewall of container 102 for use of handling container 102.

A lid 104, installed on top of container 102, is provided for closing up the open top of container 102. Lid 104 is, preferably, made from a transparent material, such that users can observe cooking processes.

A heated bottom 106, sealingly engaged with the lower end of container 102, is provided for closing up the open bottom of container 102 to form a cooking chamber 103. Heated bottom 106 has a flat bowl-shaped configuration with the open side facing upward, a sidewall of a predetermined height, and a central aperture on the bottom. A flat flange 106a is integrally formed around the open periphery for engaging with the lower end of container 102. Heated bottom 106 is made from a metal material of high thermal conductivity. Flange 106a is disposed at a predetermined distance above the bottom of heated bottom 106, such that flange 106a is sufficiently far away from the heating element on the bottom and the temperature at flange 106a is sufficiently lower than that of where is close to the heating element. In this case, the requirements on the parts abutting heated bottom 106 are significantly reduced, from a heat-loading point of view.

Heated bottom 106 can be an integrally die-cast component or any other suitable design, such as is illustrated in FIG. 1, as an example, a two-piece component, including a stainless steel main body 106b and an clad aluminum bottom piece 106c.

Other configurations for heated bottom 106 are readily applicable to fulfill its functionality, for examples, a flat one or a reverse bowl-shaped one, as known to those skilled in the art and suggested by this invention disclosure.

A sealing ring 108 is installed in between the lower end of container 102 and flange 106a for sealing off the interface thereof. As container 102 is tightened toward heated bottom 106, sealing ring 108 is squeezed to generate a seal thereof.

An adapting member 110, having a generally hollow cylindrical configuration, is provided for supporting cooking chamber 103. The upper end of adapting member 110 is engaged with the lower portion of container 102 by means of threading 102a. The lower end of adapting member 110 is extended downward to a predetermined distance, such that cooking chamber 103 is adapted to stand on a stir base 112 for cooking food or on a horizontal countertop or a dinning table for serving food. Heated bottom 106 is sealingly supported inside adapting member 110 around flange 106a. Adapting member 110 is provided also for enclosing the space underneath the bottom of heated bottom 106 into a protected space for safety considerations. A bottom cover 150, installed on the bottom of adapting member 110, is provided for closing up the open bottom of adapting member 110.

A stirrer 114, installed inside cooking chamber 103, is provided for stirring food. Stirrer 114 is adapted to rotate to generate food movement within cooking chamber 103 and to scrape off food built-up on the heated surface to facilitate heat transfer and uniform heating of food. The lower edge of stirrer 114 substantially conforms the bottom and side of heated bottom 106 with minimal clearance in between for ideal stirring performance.

An electrical heating tube 116, having a generally circular configuration, is provided for heating food disposed inside cooking chamber 103. Heating tube 116 is fixedly installed on the outside surface of the bottom of heated bottom 106 and is disposed substantially close to the periphery.

There are significant advantages of installing heating tube 116 directly on the bottom of cooking chamber 103. These advantages include saving a significant amount of material for building a full heater that has a thermal diffusion plate, resulting in space and cost saving and higher heat transfer efficiency, etc.

A plurality of co-rotation prevention members 118 is integrally constructed inside container 102, on the sidewall, for preventing food pieces from co-rotating with stirrer 114, as stirrer 114 rotates. Members 118 include an elongated member, preferably, rib-shaped, that extends generally vertical along the sidewall of container 102. The upper ends of members 118 extend substantially to the upper portion of container 102. Members 118 extend inward to a predetermined distance, away from the sidewall of container 102. The predetermined distance is determined based on the size of container 102. Member 118 acts also as a deflector for deflecting liquid flow directions for facilitating mixing or stirring of food.

A thermostat 120, installed on the bottom of heated bottom 106, at a location substantially close to heating tube 116, is provided for detecting the temperature of the bottom. Such temperature is used to control the electrical power to heating tube 116. Thermostat 120 can be a digital sensor, such as a NTC or PTC, or an adjustable thermostat, or simply a thermal protector, as known to those skilled in the art and suggested by this invention disclosure.

Stir base 112, disposed underneath cooking chamber 103, is provided for supporting cooking chamber 103. The upper portion of stir base 112 is removably engaged with the periphery of the lower portion of adapting member 110 for lockably holding cooking chamber 103 in position.

An electrical port 122, installed on top of stir base 112, is provided for supplying electrical power to heating tube 116, as cooking chamber 103 is installed on stir base 112. Port 122 is adapted to removably receive an electrical connector 128, which communicates with heating tube 116.

A motor 124 is installed inside stir base 112 for providing rotation power to stirrer 114. Motor 124 is removably coupled with a drive shaft 126, as cooking chamber 103 is installed in position on stir base 112, and the upper end of shaft 126 is engaged with stirrer 114.

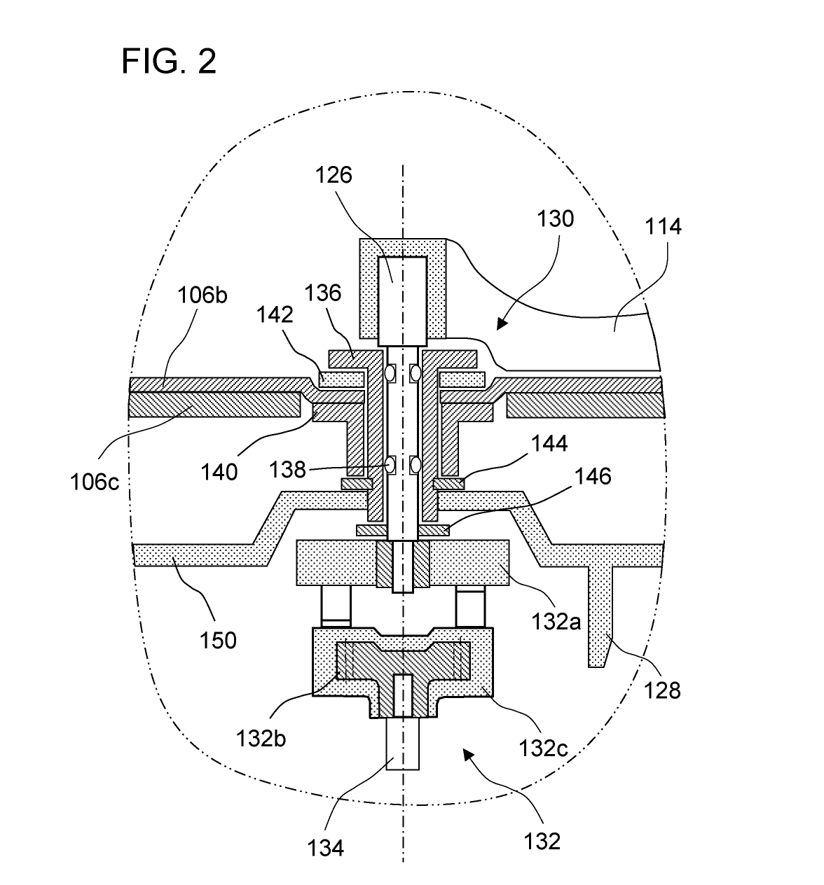

FIG. 2 illustrates an exploded cross-sectional view of a seal device 130 and a coupling device 132. Seal device 130, provided for sealing off the interface between shaft 126 and the bottom of heated bottom 106, comprises a bushing member 136 and packing 138. Coupling device 132 includes an upper coupling element 132a, which is engaged with the lower end of shaft 126, and a lower coupling element 132b, which is engaged with a motor shaft 134.

Bushing 136 is co-axial to shaft 126 and is fixedly and sealingly engaged with the bottom of heated bottom 106. A flanged tube 140 is installed on the bottom of heated bottom 106 for firmly holding bushing member 136 in position. Bushing member 136 is threaded through tube 140 by means of tight fitting. Tube 140 can be an integral part of heated bottom 106 or a separate part engaged with heated bottom 106, as known to those skilled in the art. A seal element 142 is installed in between the flange portion of bushing member 136 and the bottom of heated bottom 106 to seal off the interface thereof. As bushing member 136 is forced into tube 140, seal element 142 is squeezed to form a seal thereof. A clip 144 is installed on bushing member 136 and is disposed against the lower end of tube 140 for preventing bushing member 136 from becoming loose. A spacer 146 is installed on drive shaft 126 and is disposed in between the lower end of bushing member 136 and coupling element 132a for minimizing friction, as drive shaft 126 rotates.

Packing 138 is inserted inside a groove cut around shaft 126. A plurality of packing 138 can be provided for more reliable sealing, as known to those skilled in the art. When inserted into bushing 136 together with shaft 126, packing 138 is squeezed against shaft 126 and bushing 136 to seal off the interface thereof. The clearance between bushing 136 and shaft 126 is minimized for ideal sealing performance, but shaft 126 should be able to rotate with minimal friction resistance, which requires high precision of the fitting surfaces thereof.

Materials for packing 138 are extremely important when selecting the proper seal for an application. Basic requirements include heat resistance, abrasion resistance, elasticity, etc.

Seal device 130 can, alternatively, take many other forms, such as bushing, labyrinth, packing, or combinations of multiple forms for ideal performance, as known to those skilled in the art and suggested by this invention disclosure.

A thermal insulation material 132c is provided in between element 132a and element 132b for preventing heat from directly transferring from drive shaft 126 to motor shaft 134 through coupling device 132, such that heat transferred from the bottom of heated bottom 106 is prevented from directly passing through to motor 124.

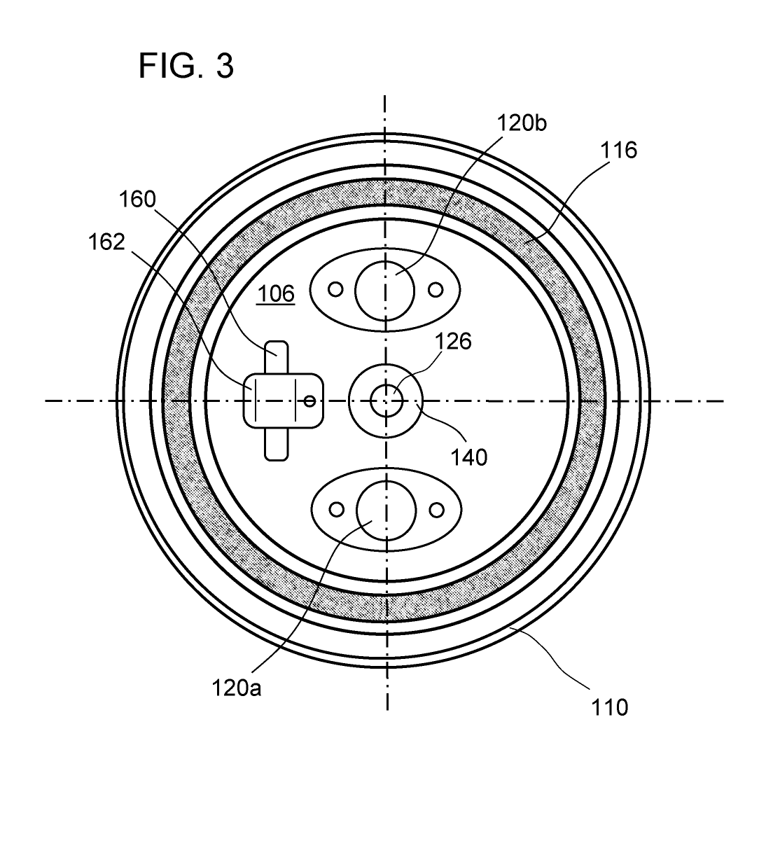

FIG. 3 illustrates a bottom view of heated bottom 106 to depict the general layout of various components disposed on the bottom. Two thermal protectors, generally designated as 120a and 120b, respectively, are installed on the bottom of heated bottom 106. Each of thermal protectors 120a and 120b can provide at least one temperature setting for stir cooking 100, such that multiple temperature settings are readily available. A thermal fuse 160 is installed on heated bottom 106 by means of a clip 162. Fuse 160 is provided for preventing stir cooker 100 from adverse events, such as over-heating due to malfunction of thermostat 120 or excessive electrical current passing through due to accidental circuit shorting, etc. In these adverse events, fuse 160 would break to shut off the electrical power to heating tube 116 for the safety of its users.

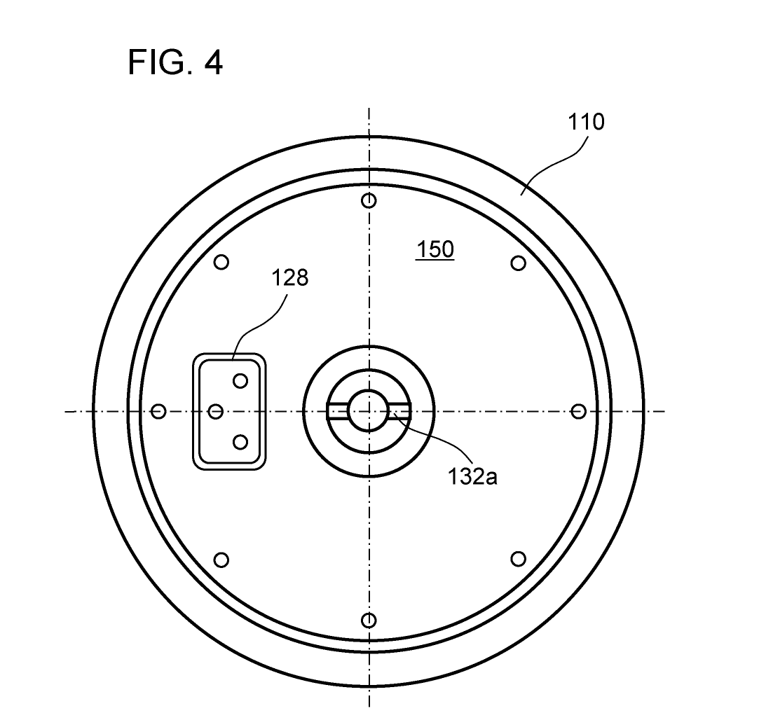

FIG. 4 illustrates a bottom view of adapting member 110 to depict the general layout of various components disposed on the bottom of member 110. Electrical connector 128, which communicates with the electrical circuit to heating tube 116, is installed on the bottom of bottom cover 150. Connector 128 is provided for receiving electrical power from stir base 112 via electrical port 122 and for supplying the power to heating tube 116. As adapting member 110 is installed on stir base 112, connector 128 is engaged with electrical port 122.

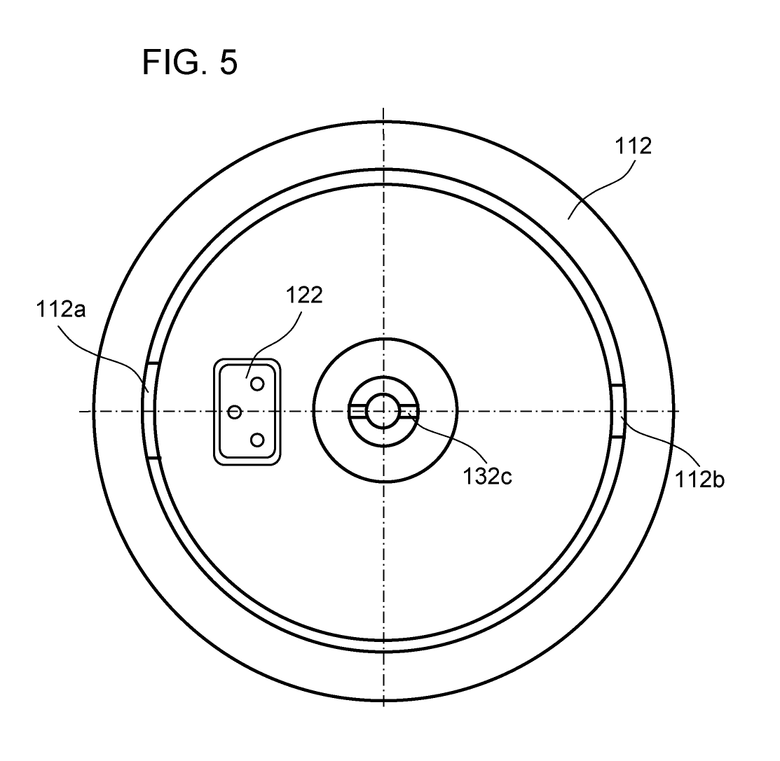

FIG. 5 illustrates a top view of stir base 112 to depict the general layout of various components disposed on the top of stir base 112. Electrical port 122 is installed on top of stir base 112 for removably receiving electrical connector 128, such that electrical power from stir base 112 is provided to heating tube 116, as cooking chamber 103 is installed in position on stir base 112.

Two base guides, slots of predetermined width and depth, generally designated as 112a and 112b, are disposed at the upper periphery of stir base 112, for selectively receiving corresponding position guides, generally designated as 110a and 110b, protrusions on adapting member 110, such that only a predetermined position would allow adapting member 110 to stand properly on stir base 112. As adapting member 110 is properly disposed on stir base 112, cooking chamber 103 is prevented from rotating with respect to stir base 112.

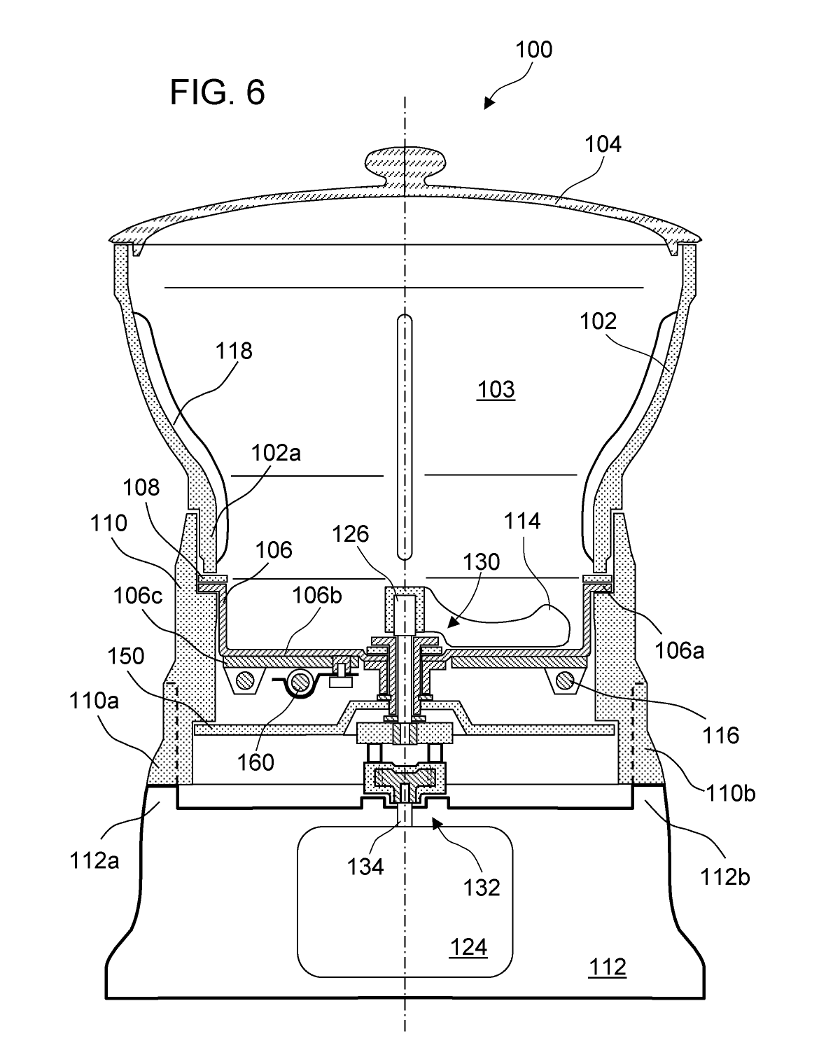

FIG. 6 illustrates another cross-sectional view of stir cooker 100 to better describe how cooking chamber 103 is installed on stir base 112. Position guides 110a and 110b on adapting member 110 are inserted into base guides 112a and 112b on stir base 112, respectively, such that cooking chamber 103 is removably locked in position on stir base 112, limiting the rotation of cooking chamber 103 with respect to stir base 112.

Accordingly, as cooking chamber 103 is properly installed in position on stir base 112, motor 124 is coupled with drive shaft 126 and electrical connector 128 is engaged with electrical port 122.

Accordingly, readers will see that this stir cooker can be used to cook food of a smaller portion. The unique tubular design of the container makes the stir cooker highly convenient for cleaning after use. An attached electrical heating tube is highly efficient in heating food, thereby saving time and energy to consumers. An adapting member is engaged with the container and the heated bottom by means of threading to form a sealed cooking chamber and, therefore, the cooking chamber is removable for cleaning after use.

The present invention has been described in an illustrative manner. It is to be understood that the terminology, which has been used, is intended to be in the nature of words of description rather than of limitation.

Although this invention has been described in its preferred forms and structures with a certain degree of particularity, these should not be construed as limiting the scope of the invention but as merely providing illustrations of some of the presently preferred embodiments of this invention.

Thus it is understood that the present disclosure of the preferred forms can be changed in the details of construction and in the combination and arrangement of parts without departing from the spirit and the scope of the invention as hereinafter claimed.

What is claimed is:

1. A stir cooker, said stir cooker comprising:
a container having an open top and an open bottom for holding food;
a lid installed on top of said container for closing up the open top of said container;
a heated bottom sealingly engaged with the open bottom of said container for forming a cooking chamber for cooking food;
a seal member disposed in between the lower end of said container and the open top of said heated bottom for sealing off the interface thereof;
stir means installed inside said cooking chamber for stirring food;
a stir base disposed underneath said cooking chamber for supporting said cooking chamber;
a motor installed inside said stir base for driving said stir means;
wherein said motor is removably coupled with a drive shaft, said drive shaft is threaded through a central aperture opened on the bottom of said heated bottom, and said drive shaft is engaged with said stir means;
an adapting member engaged with the lower portion of said container for supporting said container and for adapting said cooking chamber to stand on said stir base; and
wherein said heated bottom is supported inside said adapting member and, as said container is tightened onto said adapting member, said seal member is squeezed to form a seal thereof.

2. A stir cooker as defined in claim 1, wherein said container is made from a transparent material and whereby users can see through said container for observing cooking processes.

3. A stir cooker as defined in claim 1, wherein said heated bottom has a flat bowl-shaped configuration with the open side facing upward, said heated bottom includes a sidewall of a predetermined height and a flat flange integrally formed around the open periphery for sealingly engaging with the lower end of said container, and said flat flange is supported inside said adapting member.

4. A stir cooker as defined in claim 1, wherein said adapting member is engaged with the lower portion of said container by means of threading, such that said container is removable from said adapting member, and whereby both said container and said adapting member are convenient for cleaning after use.

5. A stir cooker as defined in claim 1, wherein said adapting member includes a bottom cover for closing the open bottom of said adapting member and an electrical connector is installed on the bottom of said bottom cover for receiving electrical power from said stir base as said adapting member is installed on said stir base.

6. A stir cooker as defined in claim 1, wherein a thermostat is installed on the bottom of said heated bottom for detecting and limiting the temperature of said heated bottom, such that said heated bottom and the neighboring components are not overheated.

7. A stir cooker as defined in claim 1, wherein said heated bottom includes a seal device for sealing off the interface between said drive shaft and the bottom of said heated bottom, said seal device includes a bushing member fixedly and sealingly engaged with a central aperture opened on the bottom of said heated bottom, and said drive shaft is threaded through said bushing member.

8. A stir cooker as defined in claim 7, wherein said seal device includes at least one seal packing for sealing off the interface between said drive shaft and said bushing member.

9. A stir cooker as defined in claim 8, wherein said at least one seal packing is inserted into a groove cut around said drive shaft and, as inserted inside said bushing member together with said drive shaft, said at least one seal packing is squeezed to form a seal thereof.

10. A stir cooker as defined in claim 1, wherein a heating tube of a circular configuration is fixedly installed on the bottom of said heated bottom for heating food and said heating tube is disposed substantially close to the periphery of the bottom of said heated bottom.

11. A stir cooker as defined in claim 1, wherein said stir base includes an electrical port installed on top of said stir base for supplying electrical power to said heated bottom and wherein, as said cooking chamber is installed on said stir base, said electrical port removably receives the electrical terminals that communicates with said heated bottom.

12. A stir cooker as defined in claim 1, wherein said container includes at least one co-rotation prevention member installed on the sidewall of said container for preventing food from co-rotation with said stir means, as said stir means rotates, and wherein said at least one co-rotation prevention member is extended generally vertical along the sidewall of said container, is generally rib-shaped, is extended from the lower portion of said container upward to the upper portion of said container, and is extended inward from the sidewall of said container to a predetermined distance, away from the sidewall of said container.

13. A stir cooker as defined in claim 1, wherein a thermal fuse is installed on the bottom of said heated bottom for limiting the temperature of said heated bottom and for limiting the electrical current to said heated bottom to prevent accidental events.

14. A stir cooker as defined in claim 1, wherein said adapting member includes at least one position guide for guiding said cooking chamber in position on said stir base, said stir base includes at least one base guide for removably receiving said at least one position guide from said adapting member, such that said cooking chamber is guided in position on said stir base and the rotation of said cooking chamber with respect to said stir base is limited.

15. A stir cooker, said stir cooker comprising:
a container having an open top and an open bottom for holding food;
a lid installed on top of said container for closing up the open top of said container;
a heated bottom sealingly engaged with the open bottom of said container for forming a cooking chamber for cooking food;
a seal member disposed in between the lower end of said container and the open top of said heated bottom for sealing off the interface thereof;
a heating tube of a circular configuration fixedly installed on the bottom of said heated bottom for heating food;
a thermostat installed on the bottom of said heated bottom for detecting and limiting the temperature of said heated bottom, such that said heated bottom and the neighboring components are not overheated;
stir means installed inside said cooking chamber for stirring food;
a stir base disposed underneath said cooking chamber for supporting said cooking chamber;
an electrical port installed on top of said stir base for supplying electrical power to said heating tube;
a motor installed inside said stir base for driving said stir means;
wherein said motor is removably coupled with said stir means;
an adapting member engaged with said cooking chamber for adapting said cooking chamber to stand on said stir base;
wherein said adapting member is engaged with the lower portion of said container by means of threading, such that said container is removable from said adapting member for cleaning after use; and
wherein said heated bottom is supported inside said adapting member and, as said container is tightened onto said adapting member, said seal member is squeezed to form a seal thereof.

16. A stir cooker as defined in claim 15, wherein said container is made from a transparent material and whereby users can see through said container for observing cooking processes.

17. A stir cooker as defined in claim 15, wherein said heated bottom has a flat bowl-shaped configuration with the open side facing upward, said heated bottom includes a sidewall of a predetermined height and a flat flange integrally formed around the open periphery for sealingly engaging with the lower end of said container, and said flat flange is supported inside said adapting member.

18. A stir cooker as defined in claim 15, wherein said container includes at least one co-rotation prevention member installed on the sidewall of said container for preventing food from co-rotation with said stir means, as said stir means rotates.

19. A stir cooker as defined in claim 15, wherein a thermal fuse is installed on the bottom of said heated bottom for limiting the temperature of said heated bottom and for limiting the electrical current to said heating tube to prevent accidental events.

20. A stir cooker as defined in claim 15, wherein said adapting member includes at least one position guide for guiding said cooking chamber in position on said stir base, said stir base includes at least one base guide for removably receiving said at least one position guide from said adapting member, such that said cooking chamber is guided in position on said stir base and the rotation of said cooking chamber with respect to said stir base is limited.
